(19) United States
(12) Patent Application Publication
(10) Pub. No.: US 2011/0041148 A1
(43) Pub. Date: Feb. 17, 2011

(54) BLACKOUTS OF PAY PER VIEW MULTIMEDIA CONTENT

(75) Inventors: David J. Piepenbrink, Chicago, IL (US); Lee M. Chow, Naperville, IL (US); James T. Sofos, Aurora, IL (US)

Correspondence Address: AT&T Legal Department - JW;Attn: Patent Docketing, Room 2A-207, One AT&T Way, Bedminster, NJ, 07921, US

(73) Assignee: AT&T INTELLECTUAL PROPERTY I, L.P., Reno, NV (US)

(21) Appl. No.: 12/540,782

(22) Filed: Aug. 13, 2009

(51) Int. Cl. H04N 7/16

(52) U.S. Cl. 725/28; 725/109; 725/104

(57) ABSTRACT

Blackout event data is received that includes data regarding a geographic area affected by a blackout event. Based on a user location code such as a ZIP code, a determination is made whether a user account is subject to the blackout event. If the user is subject to the blackout event, access to a pay-per-view multimedia event is restricted.

### BACKGROUND

1. Field of the Disclosure

The present disclosure generally relates to systems and methods for multimedia content distribution, and more particularly to systems and methods for providing conditional access to multimedia content.

2. Description of the Related Art

Multimedia content providers may provide multimedia content to users subject to blackout restrictions. In some traditional systems, blackout restrictions can be enforced with a granularity determined by server-side hardware components.

### BRIEF DESCRIPTION OF THE DRAWINGS

FIG. 1 is a block diagram of an exemplary system for providing conditional access to multimedia content in accordance with disclosed embodiments;

FIG. 2 illustrates selected details of a multimedia processing resource (MPR) for receiving multimedia content subject to blackout restrictions;

FIG. 3 is a sequence diagram for a method for updating electronic programming guides (EPGs) while providing multimedia content subject to blackout restrictions in accordance with disclosed embodiments;

FIG. 4 is a sequence diagram for a method for providing pay-per-view multimedia content subject to blackout restrictions in accordance with disclosed embodiments; and

FIG. 5 is a sequence diagram for a method for providing geographic area specific blackout messages while providing multimedia content subject to blackout restrictions in accordance with disclosed embodiments.

### DESCRIPTION OF EXEMPLARY EMBODIMENTS

Service providers receive multimedia content for distribution to users (e.g., subscribers). In some cases, the service providers distribute the multimedia content subject to blackout restrictions. Disclosed embodiments permit service providers to enforce blackout restrictions according to geographic areas based on user location codes (e.g., postal codes).

In some embodiments, disclosed methods include receiving blackout event data representing a geographic area affected by a blackout event, determining whether a user account is based within the geographic area, and restricting access to a pay-per-view multimedia program if the user account is based within the geographic area. In some embodiments, determining whether the user account is based within the geographic area includes comparing a location code for a user account to a list of known location codes subject to the blackout event. The location code may be a physical address, a postal code, or telephone area code, as examples. If the user is based within the geographic area and the user is subject to the blackout event, the method may include providing an indication of replacement programming in an EPG. In some embodiments however, indications of the pay-per-view blackout event may be restricted from user access.

In other embodiments, blackout restrictions are enforced within a geographic area defined by a radius from a particular location. For example, if a sporting event occurs at a stadium, to encourage live attendance at the stadium, a blackout restriction may be enforced within a specified distance of the stadium. As a precondition to receiving rights to film and simultaneously broadcast the sporting event, a service provider may agree to broadcast only outside the geographic area defined by a specified radius from the stadium. Accordingly, disclosed embodiments may be enabled for determining which users are located within, for example, a specified radius of the stadium so that the service providers may prevent such users from receiving a broadcast of the sporting event. In some embodiments, disclosed embodiments analyze user location codes (e.g., postal zone improvement codes, or “ZIP” codes) associated with user accounts in addition to a known location of the stadium to determine which users are within a specified radius of the stadium.

In one aspect, a disclosed method includes receiving blackout event data representing a geographic area affected by a blackout event. A determination is made whether a user account is based within the geographic area. The determination may be made according to a location code for the user account. Examples of location codes include physical addresses, ZIP codes, or telephone area codes. If the user account is determined to be based within the geographic area, the method includes restricting access to specified multimedia programming. To notify the user of the blackout, the user may be provided with an indication of replacement programming in an EPG.

Still other embodiments include instructions stored on at least one tangible computer readable medium and executable by a machine. Instructions are included for receiving blackout event data representing a geographic area affected by a blackout event, determining whether a user account is based within the affected geographic area, and restricting a user of the user account from accessing selected multimedia programming if the user account is based within the affected geographic area. In some embodiments, determining whether a user account is based within the geographic area is at least partially responsive to analyzing a user location code for the user. The user location code may be a physical address, a postal code (e.g., a ZIP code in ZIP+4 format), or telephone area code. Further instructions may restrict users of the user account from viewing an indication of the selected multimedia programming in an EPG if the user account is based within the geographic area. Set-top boxes (STBs) or other customer premises equipment (CPE) may periodically receive data regarding the enforcement of blackout events. Receiving such blackout data may occur at a pre-scheduled time. In some embodiments, receiving blackout data may be responsive to scheduling the blackout event by server-side devices.

In another aspect, a disclosed method includes receiving blackout data that includes location codes affected by a blackout event, receiving user location code data, and determining based on the received user location code data and the received blackout data whether a user is subject to the blackout event. The method further includes providing EPG data with an indication of the blackout event when the user is subject to the blackout event. If the user is not subject to the blackout event, the blackout event indication is omitted from the EPG. User location code data may include a street address, a postal code, or a telephone area code, as examples. The method may include updating a previously received EPG data in real-time with data indicative of a blackout event. In some embodiments, a set of location codes affected by the blackout event is determined based on geographic boundary data. In some embodiments, the method includes presenting an EPG with an indication of whether a retune will occur. In the event of a retune, an indication (e.g., a title) of substituted multimedia content is presented to the user. EPG data may be streamed as it is processed for presenting to the user or may be provided for storage to CPE devices associated with users subject to blackout events. Updating EPG data may occur responsive to the scheduling by a content provider of the blackout event or may occur according to a predetermined or periodic schedule (e.g., daily).

In still another aspect, a disclosed system includes service delivery resources receiving data representing a geographic area within which to enforce a blackout event. The system further includes acquisition resources for receiving multimedia content for distribution outside the geographic area. Delivery resources present the multimedia content to users. A conditional access module determines, according to a user location code, whether a user is based within the geographic area. An EPG server provides an EPG with an indication of the blackout event responsive to the conditional access module determining that the user account is based within the geographic area.

In another aspect, disclosed systems include a tangible computer readable medium with machine executable instructions for receiving blackout event data representing a geographic area affected by a blackout event. Further instructions determine whether a user account is based within the geographic area affected by the blackout event according to a user location code. If the user account is based within the geographic area affected by the blackout event, an indication of the blackout event is provided to users in response to user input to view an EPG. The user location code may include a physical address, a postal code, or a telephone area code, as examples. In some embodiments, instructions provide an indication of replacement programming in an EPG if the user account is based within the geographic area.

In still another embodiment, a disclosed system includes acquisition resources for receiving multimedia content and service delivery resources for presenting the multimedia content as a pay-per-view event. A conditional access module receives data representing a geographic area within which to enforce a blackout event and determines, according to a user location code, whether a user account is based within a geographic area subject to the blackout event. The conditional access module restricts user access to the pay-per-event responsive to the conditional access module determining that the user is based within the geographic area. Alternatively, the conditional access module provides user access to the pay-per-view event responsive to determining that the user account is not based within the geographic area. The user location code may be a physical address, a postal code, telephone area code, or the like. The system may include an EPG server that provides an indication of a substitute pay-per-view event responsive to determining that the user account is based within the geographic area. The EPG server may restrict access to certain EPG data associated with the pay-per-view event responsive to determining that the user account is based within the affected geographic area.

Other embodiments include computer executable instructions stored on tangible computer readable media to enable data processing systems (e.g., STBs) to receive blackout event data including data representing a geographic area affected by a blackout event, determine whether a user account is based within the geographic area, and restrict a user of the user account from accessing a pay-per-view multimedia program in response to determining that the user account is based within the geographic area. Users of the user account may be prevented from viewing an indication of the pay-per-view multimedia program in an EPG if the user account is based within the affected geographic area. Blackout events may be enforced by CPE devices such as STBs, and data related to the blackout events may be downloaded periodically and stored locally to client devices. Such blackout event data may be received by a CPE device at a pre-scheduled time or in response to a data push from an IPTV network, for example after a blackout event is scheduled on the server side.

Other embodiments relate to a system with acquisition resources for receiving a pay-per-view multimedia program and providing the pay-per-view multimedia program to regional service delivery resources associated within a geographic region. Conditional access resources determine whether individual users of a plurality of users within the geographic region are subject to a blackout event. Determining whether the users are subject to the blackout event is based at least in part on respective user location codes associated with the users. Delivery resources provide the pay-per-view multimedia program to users that are not subject to the blackout event. Users that are subject to the blackout event are restricted from receiving the pay-per-view multimedia program by the delivery resources, and may be restricted from receiving indications of the blacked out event by an EPG server.

Other embodiments include receiving blackout event data that includes a plurality of location codes representing geographic areas affected by a blackout event and a plurality of blackout messages. A determination is made whether a user is subject to the blackout event based on the blackout data. A blackout message is selected from the plurality of blackout messages based on a user location code. The blackout message may indicate alternate multimedia programs and may include static images. Blackout messages are associated with user location codes and a blackout message is selected for a user based on the user's location code. The selected blackout message is provided to a user that is affected by the blackout event. The method may further include determining whether a user is subject to the blackout event. If the user is not subject to the blackout event, the user is presented an EPG guide with an indication of an original multimedia program that is subject to the blackout event in other areas. Blackout messages may include an indication of a retune and a title of a substituted multimedia program.

In another aspect, disclosed systems may include service delivery resources that receive blackout event data including one or more geographic regions in which to enforce a blackout event. Acquisition resources receive multimedia content and a conditional access module determines, according to a user location code, whether a user account is based within a geographic area affected by the blackout event. A message server determines whether the user account is based within the geographic area, selects an indication of the blackout event from a plurality of blackout events based on the user location code, and provides the indication of the blackout event to a CPE device associated with the user account. In some embodiments, the indication of the blackout event includes an indication of multimedia content substituted for a blacked out multimedia program.

In other aspects, a disclosed system may receive data representing a blackout event, determine whether a CPE device associated with a user is located within a geographic area subject to a blackout event based on a user location code, and select an indication of the blackout event based on the user location code if the user account is associated or located within the geographic area. An indication of the blackout event is provided to the CPE device and is selected from a plurality of messages for the user based on the user location code. The user location code may include a physical address, a postal code, an area code, or other such indicators of geographic regions. Blackout messages may include indications of substitute programming, still images, or moving images, as illustrative and non-limiting examples.

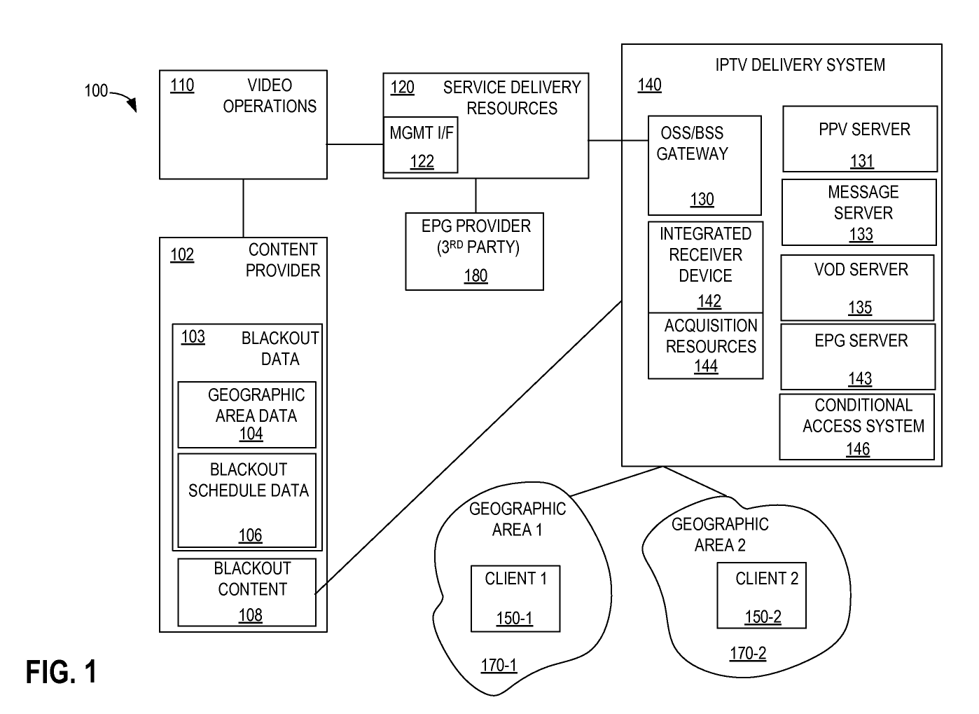

Exemplary embodiments are discussed below in the context of the attached figures. FIG. 1 illustrates an exemplary system 100 for distributing multimedia content subject to blackout restrictions. As shown, system 100 includes content provider 102, video operations unit 110, service delivery resources 120, and Internet protocol television (IPTV) delivery system 140. In accordance with disclosed embodiments, content provider 102 may be any entity that provides multimedia content subject to access restrictions enforced on a per-geographic-area basis. Examples of such content providers include IPTV service providers that act as movie or television content providers, sporting event content providers, musical content providers, and the like.

IPTV delivery system 140 may include various servers and systems involved in the delivery of IPTV services to end users of clients 150 in various geographic areas 170. In some embodiments, IPTV delivery system 140 includes Operational support system and business support system (OSS/BSS) gateway 130, acquisition resources 144, and conditional access system 146.

As shown in FIG. 1 integrated receiver device (IRD) 142 and acquisition resources 144 may include one or more devices for receiving video assets from sources including satellite links, dedicated video networks, and microwave links. OSS/BSS gateway 130 includes subscriber management resources for activating, filling, and providing IPTV services in real-time to meet customer requests. Additionally, OSS/BSS gateway 130 may process information including subscriber name and address (e.g., including user location codes), billing and payment details, IPTV assets, and IP addresses. OSS/BSS gateway 130 may gather usage information associated with a user account, monitor the status of requests from users, store databases of hardware and software resources used by subscribers, manage and support providers of multimedia content, manage user accounts and profiles, and provide users with a portal (e.g., an Internet-based Web portal) for accessing user account information. In accordance with disclosed embodiments, OSS/BSS gateway 130 may store and process user location codes associated with user accounts. Example location codes include telephone area codes, zip codes, and the like. In response to a blackout event, OSS/BSS gateway 130 may provide the location codes to conditional access system 146, for example, for determining whether a user is subject to a blackout event. Service delivery resources 120 forward blackout event data to OSS/BSS gateway 130 of IPTV system 140. OSS/BSS gateway 130 may store the blackout data and/or forward the blackout data to other systems within IPTV system 140, such as conditional access system 146. In some embodiments, service delivery resources 120 may provide blackout event data to EPG server 143. This would permit dynamic updating of EPG data as blackout events are created, started, and ended.

As shown, content provider 102 may define and maintain blackout schedule data 106 and graphic area data 104. In some embodiments, geographic area data 104 is defined in terms of location codes such as ZIP codes. For example, 5-digit ZIP codes, or 5-digit plus 4-digit ZIP (i.e., ZIP+4) codes may be used. In alternative embodiments, other geographic location mechanisms may be use such as telephone area codes associated with a user account. Alternatively, user location codes that include global positioning system coordinates associated with a user account may be used for enforcing blackout restrictions.

As shown in FIG. 1, video operations unit 110 receives geographic area data 104 and blackout schedule data 106 and uses the data to provide corresponding blackout data to service delivery resources 120. Service delivery resources 120 may comprise one or more systems involved with service provisioning, including services related to providing geographically restricted content. In some embodiments, service delivery resources 120 includes a management interface 122 that may be used for inputting blackout data. In some embodiments, management interface 122 is a graphical user interface. In alternative embodiments, management interface 122 may be a communications interface that receives input data directly from one or more external systems including EPG provider 180.

Acquisition resources 144 include one or more systems that receive content from content providers. Acquisition resources 144 receive the content through one or more IRDs 142 associated with the content provider. In some embodiments, IRDs (e.g., a main and a backup) are provided at a super hub office (SHO) for each content provider (e.g. FOX or ABC). An additional IRD (not shown) for each alternate channel required to support the blackout/market protection requirements of the content provider also may be used. However, in some embodiments only one set of one or more IRDs is required to provide service on a national basis, and it is unnecessary that individual IRDs are deployed for individual geographic areas 170.

The multimedia content subject to blackout events may be organized as channels providing services, where a service is a stream of video content. A channel may include one or more services. For example, a channel may include a picture-in-picture (PIP) stream and a full screen video stream. A content provider may provide multiple channels, including primary content, secondary content, and one or more channels of substituted content. Primary content is content that may be subject to a blackout event. Secondary content may be content associated with the primary content, such as advertising content related to the primary content. Substituted content is content that may be substituted for the primary content in the event that the primary content is subject to a blackout restriction.

Referring again to FIG. 1, conditional access system 146 uses the geographic area data received by OSS/BSS gateway 130 to determine the content that may be delivered to clients 150 in geographic areas 170. As noted above, geographic areas 170 may be represented in geographic area data 104 as a list of one or more ZIP codes that are to be included in the affected geographic area. Conditional access system 146 may be a software component of another IPTV service, or it may be a standalone service within IPTV delivery system 140.

In an exemplary embodiment, as IPTV delivery system 140 receives requests for content from client 150, conditional access system 146 determines if the requested content is subject to a blackout for the geographic area where client 150 exists, based on the geographic data received by OSS/BSS gateway 130. If the requested content is subject to a blackout event based on the blackout schedule and geographic area data, conditional access system 146 causes IPTV delivery system 140 to prevent the requested primary content from being sent to the customer equipment (e.g., client 150-1). In this event, IPTV delivery system 140 may be configured to provide an on-screen display (OSD) informing the viewer that the primary content is blacked out. The OSD may provide a list of one or more channels of substituted content that may be available. Alternatively, IPTV delivery system 140 may be configured to automatically provide substitute content to the requesting customer equipment (e.g., client 150). Client 150 may be any type of equipment capable of receiving IPTV streams. For example, client 150 may be an STB, MPR, or a computer capable of decoding IPTV streams.

It will be appreciated from the above that a ZIP code level of granularity in defining a blackout area may be achieved in some embodiments. For example, geographic area 170-1 may be defined as including only one ZIP code, and geographic area 170-2 may also be defined as including only one ZIP code. Primary content may be blacked out in geographic area 170-1 while allowed in geographic area 170-2.

Some disclosed systems relate to limiting the availability of specified content to a given geography for a specific time period. Contractual agreements may force content providers to ensure that access to specified content is blacked out or limited for specified times to certain geographical regions on video carriers' systems. On an IPTV based system, this may include limited playback access to specified content that is free, subscription-based, or otherwise purchased

Disclosed systems may include software based components that apply geographical and time constraints to the purchase and/or playback rights to certain specified content. Systems that deliver a software based approach to enforcing blackout restrictions may have advantages over systems that enforce blackout restrictions based on hardware configurations, such as when access to blacked out content is restricted on a per-Video Hub Office (VHO) basis. Blackout events enforced using software based systems rather than hardware based systems (e.g., enforcing blackout events on a per-VHO basis) have advantages in that the blackout events can be provisioned when they are scheduled, rather than when they are to be enforced. Additionally, select content may be made available for purchase more quickly than with some traditional delivery processes. Also, non-mechanized blackout systems may reduce the need for manual intervention to accomplish the desired end-state, and users may benefit from having access to information regarding blackout events before the enforcement of such events.

As shown in FIG. 1, IPTV delivery system 140 includes multimedia content server 135. Multimedia content server 135 is a simplified representation of systems for managing certain multimedia content delivery services provided to users of clients 150. Managing certain multimedia content delivery services may include setting up, ending, and control of multimedia content streaming sessions between client CPE devices (e.g., clients 150) and back end multimedia content servers.

As shown in FIG. 1, a user of client 150-1 may initiate a request to IPTV delivery system 140 that is routed to multimedia content server 135 or conditional access system 146 for a determination of whether the user is authorized to view or otherwise receive the requested multimedia content asset. In accordance with disclosed embodiments, if the requested multimedia content is subject to a blackout event, the user will be denied access. However, if the requested multimedia content is not subject to a blackout event, once authorization has been verified, multimedia content server 135 may send a decryption key to client 150-1 to facilitate decryption of the multimedia content.

Multimedia content server 135 may include video delivery servers at a central location such as an IPTV data center. Individual video servers may be arranged in a cluster and feature servers interconnected via high-speed bi-directional network connections. Distributed video architectures may also be used in which clusters of IP multimedia content servers reside at an IPTV data center and additional servers reside at remote sites. Remote sites may house various types of equipment including Digital Subscriber Line Access Multiplexers (DSLAMs) and aggregation routers, for example. Distributed multimedia content services may be used to provide caching services for popular on-demand content. Back end multimedia content resources may include a number of local caching servers at different geographic locations. If requested content is not available at a local multimedia content server, a request may be redirected to another regional cluster of multimedia content servers or sent back to a central IPTV data center. Regardless, in accordance with disclosed embodiments, determining whether a user is permitted access to restricted multimedia content includes determining whether the user is subject to the blackout event.

Determining whether the user is subject to a blackout event may be in part according to a location code associated with the user or an account associated with the user. For example, a ZIP code may be associated with a user account. If a request for multimedia content is initiated from a client associated with a certain user account, conditional access system 146 may determine from a ZIP code associated with the user account whether the user is subject to a blackout event. If the ZIP code in which the user account is based is subject to the blackout event, multimedia content server 135 may respond to a request for restricted multimedia content by providing a message that the requested content is unavailable. Such messages may be provided by message server 133 to client 150-1, for example. In exemplary nonlimiting systems, such messages may appear in EPGs as text, within static images provided in place of the restricted multimedia content, or within dynamic images provided in place of the restricted multimedia content. In some embodiments, indications of alternate content may be provided to users. Examples of indications of alternate content include text, icons, graphic images, and the like.

As shown, content provider 102 has access to blackout data 103. Blackout data 103 includes geographic area data 104, blackout schedule data 106, and blackout content 108. As shown in FIG. 1, IPTV delivery system 140 includes service delivery resources 120 which are operable to receive data (e.g., geographic area data 104) representing a geographic area within which to enforce a blackout event. The geographic area data may be provided as geographic area data 104 through management interface 122.

As shown in FIG. 1, acquisition resources 144 may receive multimedia content (i.e., blackout content 108) that is subject to a blackout event. Service delivery resources 120 and/or multimedia content server 135 are operable to present the multimedia content to clients 150. Multimedia content server 135 may restrict user access to specified multimedia content responsive to conditional access system 146 determining that a user is based within a geographic area subject to a blackout event. This determination may be made by comparing a user location code (e.g., ZIP code) for the user stored within OSS/BSS gateway 130 to location codes subject to the blackout event stored in geographic area data 104. Responsive to determining that the user account is not based within the geographic area, multimedia content server 135 provides user access to the specified content. EPG server 143 may provide an indication of substitute content responsive to determining that the user account is based within the geographic area. In some cases, EPG server 143 prevents users from accessing EPG data associated with a blacked out event responsive to determining that the user is based within the geographic area. EPG server 143 may receive EPG data from EPG provider 180 and alter it for presentation to users of client 150 based on blackout data 103.

Disclosed systems may enforce blackout events for pay-per-view multimedia programs. Accordingly, acquisition resources 144, as shown in FIG. 1, may receive multimedia content and service delivery resources 120 may be operable to present the multimedia content as a pay-per-view event. Conditional access system 146 receives data representing a geographic area within which to enforce a blackout event. Conditional access system 146 determines, according to a user location code, whether a user account is based within a geographic area subject to the blackout event. Users are restricted from viewing a blacked out pay-per-view event responsive to conditional access system 146 determining that the user account is based within the geographic area subject to the blackout event. If user accounts are not associated with or based in a geographic area subject to the blackout event, conditional access system 146 allows the user access to the pay-per-view event. PPV server 131 is enabled to deliver PPV events to users. EPG server 143 may provide an indication of a substitute pay-per-view event responsive to determining that the user account is based within the geographic area. In some embodiments, EPG server 143 restricts access to indications of blacked out multimedia programs (e.g., pay-per-view events) responsive to determining that a user or user account is subject to the blackout event.

An exemplary pay-per-view event is a boxing match for which a service provider charges a fee. Such pay-per-view events are streamed to users substantially in real-time (e.g., as the boxing match occurs). To order a pay-per-view event, a user may navigate an EPG provided through an STB on a television display, for example. The user may use a remote control device to navigate one or more user interface screens and select a pay-per-view event for purchase. The STB, in an exemplary architecture, formats the purchase request and forwards the purchase request to network components (e.g., OSS/BSS gateway 130) of an IPTV service provider (e.g., system 100 in FIG. 1). The purchase of the pay-per-view event may be registered and billed to a user account associated with the STB used in making the pay-per-view purchase request. In some embodiments, purchase information is sent to a smart card with an embedded security module in a CPE device such as an STB. The smart card may process the purchase request and store validation information for the pay-per-view event.

In some embodiments, a conditional access system (e.g., conditional access system 146) determines which user accounts, or which set-top boxes assigned to a particular user account, are permitted access to a pay-per-view or similar event. The conditional access system may transmit in-band security packets such as Entitlement Control Messages (ECMs) that provide an IPTV service provider with a secure mechanism for delivering pay-per-view or other restricted content to users. The conditional access system may be located at a SHO and include encryption systems. ECMs may be created and utilized by client devices to decrypt content for playback. Pay-per-view events that are broadcast in real-time may result in a bit stream containing ECM packets in addition to audio and video packets. A smart card embedded with an onboard microprocessor that communicates with a client device (e.g., an STB) may be used for communicating with the conditional access system. When a user requests to view content that has been protected by a conditional access system, the client may need to communicate with the smart card or other embedded security module.

In embodiments that utilize smart cards, after an STB receives a user request to purchase a pay-per-view event, the STB may format the purchase data and send the purchase request to the smart card to request that the smart card add an entitlement for the STB to the pay-per-view event. The smart card may process whether to validate the request, and if the request is validated, the smart card stores a new entitlement in persistent (i.e., nonvolatile) memory. The STB may communicate with network based components (e.g., OSS/BSS systems) to bill the user account for the requested pay-per-view event.

At the scheduled start time for a pay-per-view event, the STB tunes to the proper channel for the pay-per-view event and acquires audio, video, and ECM packets. When the STB receives an ECM, it is sent to the smart card for decrypting the content using keys. Received audio and video packets may be discarded prior to the STB receiving any keys required for decryption. The smart card receives ECMs from the STB and checks the ECMs against a list of multimedia programs it is permitted to receive and process. Example multimedia programs include pay-per-view events. If the smart card determines that the STB is entitled to watch a requested event, the smart card processes the received ECMs. The smart card uses decryption keys and may re-encrypt the decryption keys with public/private keys shared by the STB. Using these shared keys, the smart card packages messages for the STB that contain encrypted keys for viewing the pay-per-view content. The STB receives the messages from the smart card and processes them to decrypt the encrypted keys with the STB's portion of the shared (i.e., public/private) keys. The STB stores decryption keys in a secure location within an STB hardware for decrypting the pay-per-view content. Once the STB has the correct decryption keys, it processes incoming audio and video packets associated with the pay-per-view event, decrypts the content, decodes the content, and renders it for presentation on a display (e.g., television).

In some embodiments, pay-per-view events may be subject to blackouts. Blackouts may be enforced according to user location codes such as ZIP codes, telephone area codes, or the like. In some embodiments, smart cards such as the ones discussed above may contain logic for determining whether a user is subject to a blackout event. For example, the smart card may update, using blackout event data, its list of available multimedia programs. Accordingly, when the smart card receives ECMs from the STB and checks the ECMs against the list of available multimedia programs, if a requested multimedia program (e.g., pay-per-view event) is unavailable, the smart card will not allow the STB access to the requested multimedia program. In some embodiments, the smart card may communicate with a conditional access server, EPG server, or other network device or CPE device to determine whether an STB is permitted to receive and process a requested multimedia program. The smart card may receive a list of user location codes (e.g., postal ZIP codes) that are subject to a blackout event. The smart card may access localized user account data or an OSS/BSS system to determine the user location code (e.g., postal ZIP code) associated with a user account or STB. If the user location code for the user account or STB is subject to the blackout event, the smart card will prevent access to the requested multimedia event.

EPGs provide users a way to choose from available multimedia content. An EPG may also be referred to as an intelligent program guide (IPG) or an event service guide. EPGs often include a graphical interface that allows users to preview, select, and receive multimedia content, data, and services. EPGs often provide a text-based menu of available IPTV channels and are navigated through input received from a remote control device. EPGs may provide a user with features for searching multimedia content by genre, program title, rating, and length. An EPG is typically displayed on a television screen and may be in tabular, grid, or graphical format.

Standard IPTV EPGs may permit users to control disk storage devices in STBs, preview multimedia programs, search for programs with a particular theme or title, restrict access to multimedia content through parental controls, receive reminders when certain multimedia content will be available, automatically record content, display certain available content, display available pay-per-view content, and display weekly schedules of multicast channels. EPGs may be presented as a PIP format, in which the menu and available content are displayed simultaneously. Alternatively, EPGs may be presented in place of available content by entering a “menu” or “guide” mode.

An exemplary EPG system architecture includes a metadata generator, an IPTV application server, and a client EPG application present on a CPE device such as an STB. The metadata generator acquires, edits, generates, and formats EPG data and provides the data to a multimedia content distribution network (e.g., an IPTV service provider). The EPG data is often provided as metadata. Metadata may include information that originates from an IPTV service provider and a content provider. Examples of metadata include channel name, channel description, channel logo, channel provider, program title, program start and finish times, program language options, recording rights, preview duration for select assets, viewing profiles of users, and content aspect ratios.

The metadata generator in the exemplary EPG system architecture discussed above interfaces with an EPG application server to deliver the metadata to the EPG client application. The EPG application server may include software programs, an HTTP server, and a database for storing EPG data for available multimedia content. Channel listings may be formatted as Web pages. The EPG application server may, in conjunction with a conditional access system, authorize access to particular content. In some cases, if a user is not authorized to view certain content, indications (e.g., selectable icons) of the content will not appear in the EPG. The EPG application server may store IP multicast addresses used by routers to stream multimedia content to access networks and end users. The EPG application server may serve a caching function to efficiently provide end users with EPG information.

The client EPG application in an exemplary EPG system architecture runs from a CPE device such as an STB. The client EPG application provides users the ability to customize lists of available multimedia content. The client EPG application may support a user setting up an EPG page listing all sporting events available through pay-per-view in the next month. The client EPG application may further support the user setting up an EPG page listing all restricted movies that have a certain actor. The client EPG application may support the user changing the format, arrangement, colors, and any sound effects associated with EPGs. EPGs may be presented on a user-by-user basis, and a user may be required to log in to receive a customized EPG. EPGs that support customization may provide users with an efficient mechanism for navigating through multimedia content and IPTV services offered from an IPTV content and service provider.

In operation, to access an EPG, a user may press on a remote control device a “menu,” “guide,” or “EPG” button. In some embodiments, an EPG may be provided similarly to a Web page. Accordingly, a network connection between the EPG browser application and an EPG backend server may be established. The Web page containing the EPG includes channel information, for example, requested by the end-user. An IPTV EPG server may send results of a user request to a client EPG browser application. Results from client requests are received by the client EPG application, rendered, and an EPG page is displayed on a television, for example, for consumption by the user.

In some embodiments, to lessen the likelihood of delays or congestion in receiving EPG data in real-time from an IPTV network, EPG data may be stored locally to an STB. An EPG application may reside on a hard drive of the STB, for example, and access current metadata from an IPTV network. Accessing the EPG data may occur during off-peak hours (e.g., during early morning hours). In accordance with disclosed embodiments, information regarding blackout data may be received with the EPG data. In the event that new blackout data is available, a network may push blackout data to localized EPG applications in response to scheduling a blackout event. Alternatively, blackout data may be pushed to a local EPG application according to a predetermined schedule, such as once every three hours or once a day. Local storage of an EPG application may speed up response times for a user, but EPG data including blackout data may be updated to the local EPG application as often as needed.

In accordance with disclosed embodiments, users may be subject to a blackout event according to a user location code such as a ZIP code. Alternatively, a specific geographic area may be subject to the blackout event. For example, a five mile radius from a sports arena may be subject to a blackout event. In such cases, blackout events may be enforced according to a user location code that includes an address for a user. Software applications may determine from geographic data defining a geographic area whether user accounts are subject to the blackout event. If the user is subject to the blackout event, the user may receive updated EPG information indicative of the blackout event and possibly indicative of replacement programming. In other cases, if a user is subject to the blackout event the EPG may not provide an indication of the blackout event or the multimedia program that is subject to the blackout event. In such cases, users that are subject to the blackout event access different EPGs compared to users that are not subject to the blackout event. Therefore, an EPG application for a user subject to a blackout event may be directed to a server that provides EPG data that contains the blackout data. The EPG application may consult a conditional access system that determines, based on user location code data, whether a user or user account is subject to a blackout event.

Some disclosed embodiments relate to processes and systems for updating a user's EPG with information indicative of an impending blackout. This EPG data may be updated in advance of a known substitution event once scheduled by operations, or at the time of the event for the users affected by the event. This may present problems associated with users only becoming aware of blackout events when they tune to the blacked out event. In the case of a retune, the EPG data for alternate programming may be displayed for the channel impacted by the retune event. A potential benefit to updating EPG data prior to a blackout event is a reduction in user dissatisfaction related to failed digital video recorder (DVR) recordings as the result of blackouts or retunes.

As shown in FIG. 1, IPTV delivery system 140 includes EPG server 143. In some embodiments, EPG server 143 is operable for providing within an EPG an indication of a blackout event responsive to conditional access system 146 determining that a user account is based within a geographic area affected by a blackout event. Conditional access system 146 may determine, according to a user location code, whether a user account is within an affected geographic area. In some embodiments, providing an EPG with an indication of the blackout event is responsive to a user selection of a multimedia program that is subject to the blackout event. The user selection of the multimedia program may be for recording or for immediate viewing. In the case of a retune, EPG server 143 may update the EPG with an indication of multimedia content substituted for the blacked out multimedia content.

In some embodiments, conditional access system 146 is communicatively coupled to at least one tangible computer readable medium embedded with computer executable instructions for receiving data representing a blackout event and determining whether a user account is based within a geographic area affected by the blackout event. If the user account is based within the geographic area affected by the blackout event, EPG server 143 includes or accesses instructions for providing an indication of the blackout event in response to user input to view an EPG. EPG server 143 executes instructions for providing an indication of replacement programming in the EPG if the user account is based within the geographic area affected by the blackout event.

In addition to disclosed systems blacking out select or otherwise restricted multimedia programs, blacking out pay-per-view multimedia programs, and updating EPGs to accurately reflect blackout multimedia content, some disclosed systems select and provide blackout messages to users based on user location codes associated with the users. Example user location codes include telephone area codes, ZIP codes, and physical addresses. Accordingly, as shown in FIG. 1, service delivery resources 120 may receive data representing a geographic area within which to enforce a blackout event and acquisition resources 144 may receive the multimedia content. Conditional access system 146 determines, according to a user location code, whether a user account is based within the geographic area. EPG server 143 may operate as message server 133 and select an indication of a blackout event from a plurality of blackout events based on the user location code. Further, EPG server 143 may provide the indication of the blackout event to a CPE (e.g., client 150) device associated with the user account responsive to a request by a user to view the blackout multimedia content. The indication of the blackout event provided by EPG server 143 may include an indication of multimedia content substituted for the blacked out multimedia program.

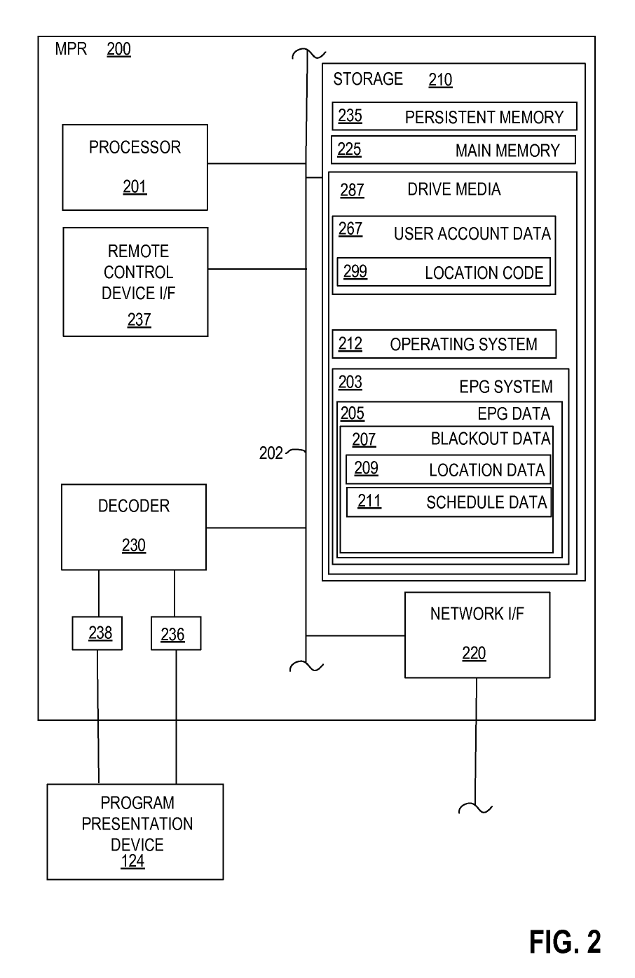

Referring to FIG. 2, a block diagram illustrating selected elements of MPR 200 is presented. In the depicted embodiment, MPR 200 includes a processor 201 communicatively coupled by bus 202 to storage 210, which includes persistent memory 235 and main memory 225. Storage 210 as shown includes multiple sets or sequences of instructions stored on drive media 287, including operating system 212, EPG system 203, and user account data 267. Operating system 212 may be a Unix® or Unix-like operating system, a Windows® family operating system, or another suitable operating system. As shown, EPG system 203 includes EPG data 205 and blackout data 207. Blackout data 207 includes location data 209 and schedule data 211. User account data 267 includes user location code 299.

MPR 200 as depicted in FIG. 2 further includes a network adapter/interface 220 that interfaces MPR 200 to an access network (e.g., IPTV delivery system 140 in FIG. 1), possibly through a residential gateway. Network adapter/interface 220 may be an IP network interface (e.g., an Ethernet interface) that allows communication over wireless (e.g., WiFi™, or Bluetooth™) and/or wired transmission paths. In embodiments suitable for use in IP based content delivery networks, MPR 200, as depicted in FIG. 2, may include an audio/video (A/V) decoder 230 that assembles payloads from a sequence or set of network packets into a stream of multimedia content. The stream of multimedia content may include audio information and video information and A/V decoder 230 may parse or segregate the two to generate a video stream 238 and an audio stream 236 as shown.

Video and audio streams 238 and 236 may include audio or video information that has been compressed, encrypted, or both. Decoder 230 may employ any video decoding algorithm including for example without limitation any of the MPEG standards or WMV standards. Similarly, decoder 230 may employ any audio decoding algorithm including for example without limitation: Dolby® Digital, Digital Theatre System (DTS) Coherent Acoustics, and Windows Media Audio (WMA). The video and audio streams 238 and 236 are provided in a format suitable for program presentation device 124, which itself may or may not be a part of MPR 200. Program presentation device 124 may comply with National Television Standards Committee (NTSC), phase alternating line (PAL) or any other suitable television standard. Program presentation device 124 may be for example without limitation a television, a display integrated with MPR 200, and a data processing system (e.g., personal computer) with a monitor.

As shown in FIG. 2, EPG system 203 may include computer executable instructions for receiving blackout event data that includes data representing a geographic area affected by a blackout event. Further instructions determine whether MPR 200 or a user account associated with MPR 200 is based within a geographic area affected by the blackout event. If the user account or MPR 200 is based within the geographic area subject to the blackout event, EPG system 203 restricts a user of MPR 200 from accessing a restricted or pay-per-view multimedia program. Determining whether MPR 200 is subject to the blackout event may be accomplished by comparing user location code 299 to a list of codes affected by the blackout event. A list of codes affected by the blackout event may be obtained over network interface 220 from an IPTV service provider. In some embodiments, EPG system 203 prevents users from viewing an indication of the restricted or pay-per-view multimedia program in an EPG if the user account or MPR 200 is based within a geographic area subject to the blackout event. In other cases, indications of the blackout event or an indication of multimedia content that is substituted for the blacked out event are provided.

In order for MPR 200 to enforce blackout events, MPR 200 must receive data related to blackout events. Accordingly, EPG system 203 may receive blackout data over network interface 220 according to a predetermined and/or periodic schedule. In some cases, an IPTV service provider pushes blackout data to MPR 200 over network interface 220 in response to the scheduling of a blackout event. Accordingly, MPR 200 may include computer executable instructions embedded on storage 210 (e.g., on drive media 287) for receiving blackout event data that includes an indication of a geographic area affected by a blackout event. The blackout event data may be received, for example, by EPG system 203. EPG system 203 may include instructions for determining whether according to user location code 299, MPR 200 or a user account associated with MPR 200 is based within the geographic area affected by the blackout event. If the user account or MPR 200 is based within the geographic area subject to the blackout event, EPG system 203 may provide an indication of the blackout event in response to user input to view an EPG. User input to view the EPG may be provided through remote control device interface 237, which receives infrared or radio signals from a remote control device. EPG system 203 may also provide an indication of replacement programming in an EPG if the MPR 200 is subject to the blackout event.

As shown in FIG. 2, MPR 200 may include further computer executable instructions embedded on storage 210 (e.g., on drive media 287) for receiving data representing a blackout event, determining whether MPR 200 and a user account associated with MPR 200 is located within a geographic area subject to a blackout event, and selecting a blackout message based on location code 299. MPR 200 may present on program presentation device 124 an indication of the blackout event that is selected according to location code 299. The selected blackout message may include an indication of replacement programming.

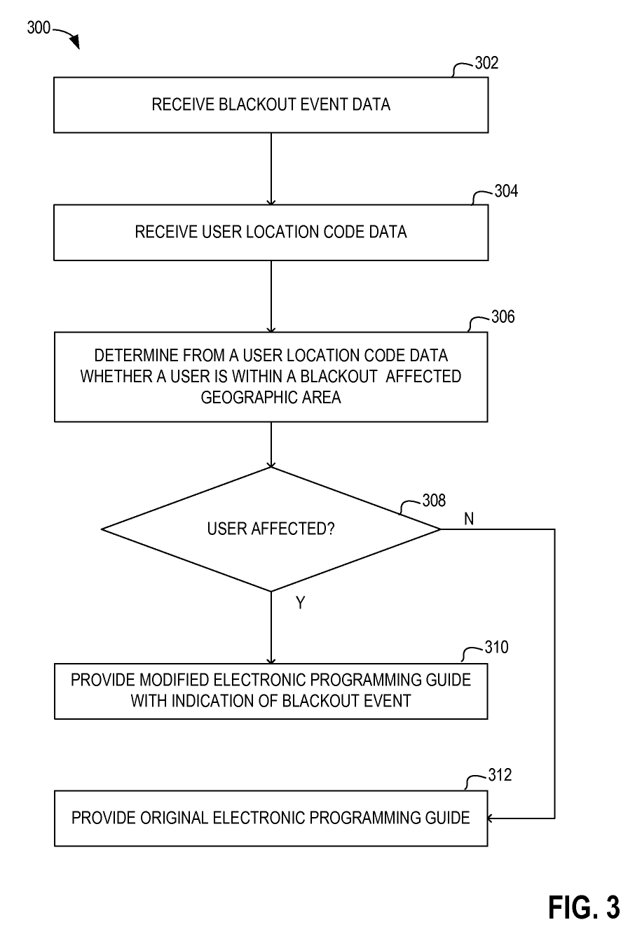

FIG. 3 illustrates a method 300 for updating an EPG with blackout data for users affected by a blackout event. As shown, method 300 includes receiving (block 302) blackout event data that includes data representing a geographic area affected by a blackout event. User location code data is received (block 304). The user location code data may include a physical address, or a ZIP code or another indication of a geographic area of a user. A determination is made (block 306) from the user location code data whether a user is within a geographic area affected by the blackout. If the user is affected (block 308), a modified EPG is provided (block 310) to the user with an indication of the blackout event. If the user is not affected (block 308) by the blackout event, the original EPG is provided block 312.

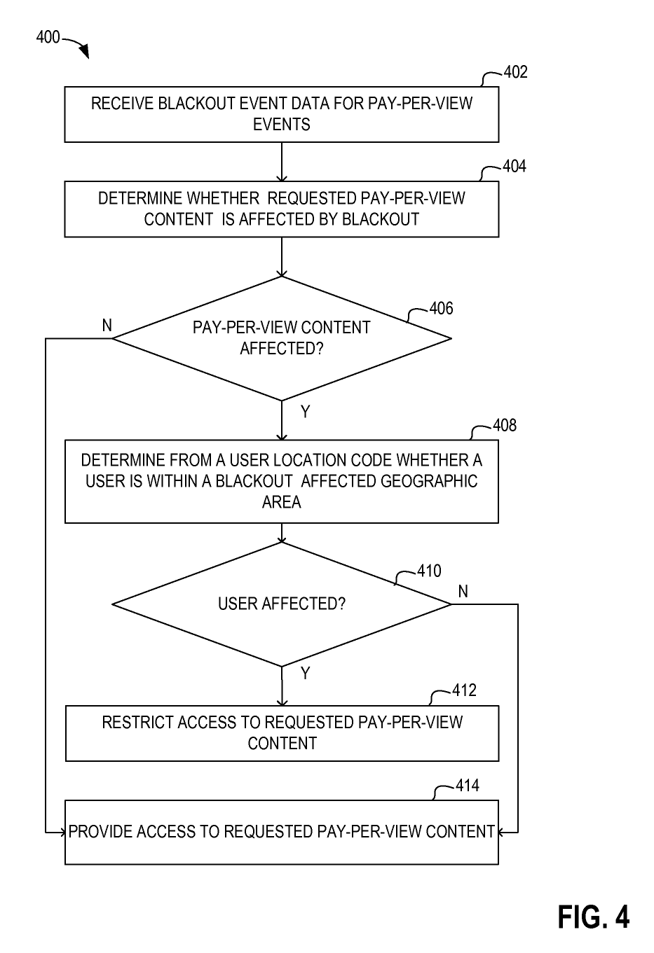

FIG. 4 illustrates a method 400 for providing to users pay-per-view multimedia content that is subject to a blackout in certain geographic areas. Method 400 may be performed by one or more elements shown in FIG. 1 (e.g., IPTV delivery system 140) or MPR 200 (FIG. 2). As shown, blackout event data is received (block 402) for a pay-per-view event. The blackout event data includes location codes that correspond to geographic areas that are affected by a blackout event. The blackout event data also includes information regarding which pay-per-view events are subject to blackout. A determination is made (block 404) whether requested pay-per-view content is affected by the blackout event. If the requested pay-per-view content is affected (block 406) by a blackout event, a determination is made (block 408) whether a user is within a geographic area that is affected by the blackout event. The determination may be made by comparing a user location code to the location codes in the blackout event data. If the user location code corresponds (block 410) to a code for affected geographic areas, access to the requested pay-per-view content is restricted (block 412). If the user, as determined by the user location code, is not affected (block 410) by the blackout event, access to the requested pay-per-view content is provided (block 414). Likewise, if the requested pay-per-view content is not affected (block 406) by a blackout event, access is provided (block 414) to the requested pay-per-view content. It will be appreciated, that while method 400 is directed to pay-per-view multimedia in FIG. 4, method 400 may be utilized with respect to the delivery of any restricted multimedia content subject to a blackout event.

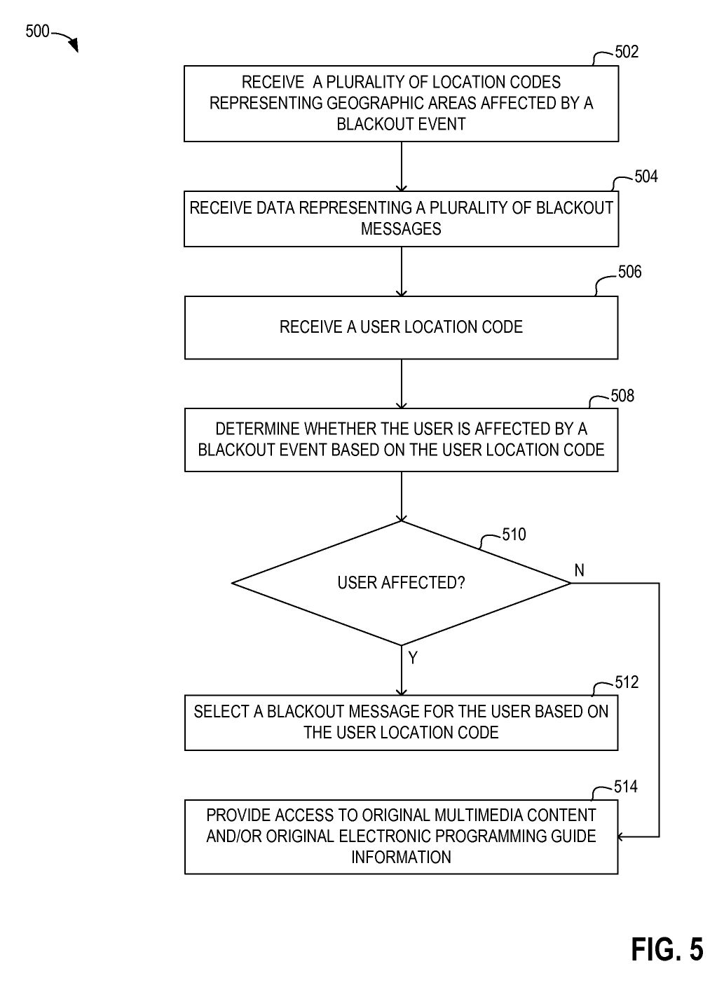

FIG. 5 illustrates method 500 for providing blackout messages to users affected by a blackout. In some embodiments, whether a user is affected by a blackout event is determined according to whether a user location code (e.g., ZIP code) corresponds to location codes affected by the blackout event. Method 500 may be performed by one or more elements shown in FIG. 1 (e.g., IPTV delivery system 140) or MPR 200 (FIG. 2). As shown, a plurality of location codes are received (block 502) that represent geographic areas affected by a blackout event. Data representing a plurality of blackout messages is received (block 504). Similarly, a user location code is received (block 506) and a determination is made (block 508) whether the user is affected by a blackout event based on the user location code. If the user is affected (block 510), a blackout message for the user is selected (block 512) based on the user location code. If the user is not affected (block 510), access to original multimedia content and/or an original EPG is provided (block 514) to the user.

To the maximum extent allowed by law, the scope of the present disclosure is to be determined by the broadest permissible interpretation of the following claims and their equivalents, and shall not be restricted or limited to the specific embodiments described in the foregoing detailed description.

What is claimed is:

1. A method comprising:
receiving blackout event data including data representing a geographic area affected by a blackout event;
determining whether a user account is based within the geographic area; and
if the user account is based within the geographic area, restricting access to a pay-per-view multimedia program.

2. The method of claim 1, wherein said determining is at least partially according to a location code for the user account.

3. The method of claim 2, wherein the location code includes a physical address.

4. The method of claim 3, wherein the physical address includes a postal code.

5. The method of claim 4, further comprising:
if the user account is based within the geographic area, providing an indication of replacement programming in an electronic programming guide.

6. The method of claim 4, further comprising:
restricting access to an indication of the pay-per-view multimedia program in an electronic programming guide if the user account is based within the geographic area.

7. The method of claim 4, further comprising:
providing an indication of said restricting access to the user.

8. The method of claim 1, further comprising:
providing pay-per-view programming via an Internet protocol television network.

9. The method of claim 1, wherein said restricting access comprises restricting access if the current time is within a predetermined blackout period.

10. A system comprising:
acquisition resources operable to receive multimedia content;
service delivery resources operable to:
present the multimedia content as a pay-per-view event; and
a conditional access module operable for:
receiving data representing a geographic area within which to enforce the blackout event;
determining, according to a user location code, whether a user account is based within a geographic area subject to a blackout event;
restricting user access to the pay-per-view event responsive to the conditional access module determining that the user account is based within the geographic area; and
providing user access to the pay-per-view event responsive to determining that the user account is not based within the geographic area.

11. The system of claim 10, wherein the user location code includes a physical address.

12. The system of claim 10, wherein the user location code includes a postal code.

13. The system of claim 12, wherein the user location code includes ZIP+4 information.

14. The system of claim 12, further comprising:
an electronic programming guide server operable for providing an indication of a substitute pay-per-view event responsive to determining that the user account is based within the geographic area.

15. The system of claim 10, further comprising:
an electronic programming guide server operable for restricting access to electronic programming guide data associated with the pay-per-view event responsive to determining that the user account is based within the geographic area.

16. The system of claim 16, wherein the electronic programming guide server is further operable for providing access to an indication of the pay-per-view event responsive to determining that the user account is not based within the geographic area.

17. A tangible computer readable medium embedded with computer executable instructions including instructions for:
receiving blackout event data including data representing a geographic area affected by a blackout event;
determining whether a user account is based within the geographic area; and
if the user account is based within the geographic area, restricting a user of the user account from accessing a pay-per-view multimedia program.

18. The tangible computer readable medium of claim 17, wherein said determining is at least partially responsive to a user location code for the user.

19. The tangible computer readable medium of claim 18, wherein the user location code includes a physical address.

20. The tangible computer readable medium of claim 19, wherein the user location code includes a postal code.

21. The tangible computer readable medium of claim 19, wherein the user location code includes ZIP+4 information.

22. The tangible computer readable medium of claim 21, further including instructions for:
restricting users of the user account from viewing an indication of the pay-per-view multimedia program in an electronic programming guide if the user account is based within the geographic area.

23. The tangible computer readable medium of claim 22, wherein said receiving blackout event data occurs at a pre-scheduled time by a customer premises equipment device.

24. The tangible computer readable medium of claim 22, wherein receiving blackout event data is in response to scheduling the blackout event.

25. A system comprising:
acquisition resources operable to:
receive a pay-per-view multimedia program;
provide the pay-per-view multimedia program to regional service delivery resources associated within a geographic region;
conditional access resources operable to determine whether individual users of a plurality of users within the geographic region are subject to a blackout event, wherein said determining is based at least in part on respective user location codes associated with the users; and
delivery resources operable to provide the pay-per-view multimedia program to individual users of the plurality of users that are not subject to the blackout event and operable to not provide the pay-per-view multimedia program to individual users of the plurality of users that are subject to the blackout event.
